(19) United States
(12) Patent Application Publication
(10) Pub. No.: US 2005/0204006 A1
(43) Pub. Date: Sep. 15, 2005

(54) Message junk rating interface

(76) Inventors: Sean E. Purcell, Seattle, WA (US); Kenneth R. Aldinger, Redmond, WA (US); Daniel Gwozdz, Sammamish, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/799,992

(22) Filed: Mar. 12, 2004

(51) Int. Cl. G06F 15/16

(52) U.S. Cl. 709/206

(57) ABSTRACT

The present invention relates to a system and/or method that facilitate viewing and organizing incoming messages based on their respective junk ratings. More specifically, the system and method provide for exposing the junk rating of substantially all messages in the user interface, thereby improving management and organization of messages. In particular, the invention involves including a junk rating of a message as an actionable property on a message. Thus, messages can be sorted, viewed, opened, and the like based in part on the message's junk rating. This can be particularly useful since messages can be misdirected to the wrong or inappropriate folders. Thus particular treatments or action rules as well as display rules can be set based on the junk rating. Furthermore, computed junk scores are categorized into a plurality of buckets thereby making it more difficult for spammers to reverse engineer the junk scores. Junk scores can also be included on the user interface.

### TECHNICAL FIELD

This invention is related to systems and methods for identifying both legitimate (e.g., good mail) and undesired information (e.g., junk mail), and more particularly to displaying an actionable junk rating field or property on a user interface.

### BACKGROUND OF THE INVENTION

The advent of global communications networks such as the Internet has presented commercial opportunities for reaching vast numbers of potential customers. Electronic messaging, and particularly electronic mail (“e-mail”), is becoming increasingly pervasive as a means for disseminating unwanted advertisements and promotions (also denoted as “spam”) to network users.

The Radicati Group, Inc., a consulting and market research firm, estimates that as of August 2002, two billion junk e-mail messages are sent each day—this number is expected to triple every two years. Individuals and entities (e.g., businesses, government agencies) are becoming increasingly inconvenienced and oftentimes offended by junk messages. As such, junk e-mail is now or soon will become a major threat to trustworthy computing.

A key technique utilized to thwart junk e-mail is employment of filtering systems/methodologies. One proven filtering technique is based upon a machine learning approach—machine learning filters assign to an incoming message a probability that the message is junk. In this approach, features typically are extracted from two classes of example messages (e.g., junk and non-junk messages), and a learning filter is applied to discriminate probabilistically between the two classes. Since many message features are related to content (e.g., words and phrases in the subject and/or body of the message), such types of filters are commonly referred to as “content-based filters”.

Some junk/spam filters are adaptive, which is important in that multilingual users and users who speak rare languages need a filter that can adapt to their specific needs. Furthermore, not all users agree on what is and is not, junk/spam. Accordingly, by employing a filter that can be trained implicitly (e.g., via observing user behavior) the respective filter can be tailored dynamically to meet a user's particular message identification needs.

One approach for filtering adaptation is to request a user(s) to label messages as junk and non-junk. Unfortunately, such manually intensive training techniques are undesirable to many users due to the complexity associated with such training let alone the amount of time required to properly effect such training. In addition, such manual training techniques are often flawed by individual users. For example, subscriptions to free mailing lists are often forgotten about by users and thus, can be incorrectly labeled as junk mail by a default filter. Since most users may not check the contents of a junk folder, legitimate mail is blocked indefinitely from the user's mailbox. Another adaptive filter training approach is to employ implicit training cues. For example, if the user(s) replies to or forwards a message, the approach assumes the message to be non-junk. However, using only message cues of this sort introduces statistical biases into the training process, resulting in filters of lower respective accuracy.

Despite various training techniques, spam or junk filters are far from perfect. Messages can often be misdirected to the wrong or inappropriate folder. Unfortunately, this can result in a few junk messages appearing in the inbox and a few good messages lost in the junk folder. Users may mistakenly open spam messages delivered to their inbox and as a result expose them to lewd or obnoxious content. In addition, they may unknowingly “release” their email address to the spammers via web beacons.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates to a system and/or method that facilitate viewing and organizing incoming messages based on their respective junk ratings. More specifically, the system and method provide for exposing the junk rating of substantially all messages in the user interface, thereby assisting a user to spend her time more efficiently when reviewing or reading her incoming messages. This can be particularly useful since the catch rates of some spam or junk filters can vary; and as a result, some junk messages can be let through to the user's inbox while some good messages can be inadvertently sent to a junk folder.

By employing the present invention, organizing messages in the inbox from the least “junky” to the most “junky” allows the user to better distinguish between good mail and junk mail in the inbox. The same can be done in any other folder where messages are stored including the junk folder to locate good messages or junk messages. By showing the junk rating of a message as an actionable property of that message, the user can manipulate the view of messages in unique and useful ways such as sorting and grouping messages, filtering out messages, and/or setting action or display rules—all of which can be based on the junk rating.

In one aspect of the present invention, the junk rating can be based on a computed junk score. The junk score can be computed to reflect a spam confidence level of the message. More specifically, the junk score can be any value or fractional value between 0 and 1, for instance. The spam confidence level can correspond to a probability that the message is spam or junk. Furthermore, the junk score can vary depending on other information extracted from the message itself, including the message headers and/or message content.

In another aspect of the invention, the junk rating can be based on whether the sender is known. More specifically, when a sender is determined to be on a safe list such as a safe sender list or a safe mailing list, the junk rating can be deemed “safe” without subjecting the message to the junk filter to obtain a junk score. Senders found in the user's address book can also be considered safe in terms of the junk rating.

According to yet another aspect of the invention, the user can essentially override a junk rating that is based on a computed junk score. This may be particularly applicable to good messages sent to the junk folder and junk messages sent to the inbox. Imagine, for example, the user has moved a message from the junk folder to the inbox. This message's previous junk rating (e.g., very high) can now be replaced with “not junk” for example to indicate that the message is not junk. Similarly, a message that has been moved from the inbox to the junk folder can have a new junk rating of “junked” to indicate that the message was manually placed in the junk folder by the user. It should be appreciated that thresholds can be set to automatically redirect messages based in part on their junk scores and/or junk ratings. In addition, the display of messages can be automatically modified or altered based in part on their respective junk scores and/or junk ratings. For instance, a message that comes through to the inbox having a “very high” junk rating can be color-coded red, whereas messages rated as “safe” can be color-coded green.

In still another aspect of the invention, a verification component can confirm whether a user-initiated action with respect to “junky-rated” messages is truly desired. For example, a user may try to respond to a junk message which is generally not recommended. Thus, when a reply to such message having a sufficiently high junk score is started or initiated by the user, the verification component can issue a warning dialog box. A similar warning can be given when moving otherwise junk messages from the junk folder to the inbox or some other folder. This feature can be customized to apply to certain messages such as those that were manually placed in the junk folder by the user and/or those that were automatically placed there by the junk filter.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a junk rating interface system in accordance with an aspect of the present invention.

FIG. 2 is a flow diagram illustrating an exemplary methodology for obtaining a junk rating as a message property in accordance with an aspect of the present invention.

FIG. 3 is a flow diagram illustrating an exemplary methodology for overriding a computed junk rating in accordance with an aspect of the present invention.

FIG. 4 is a flow diagram illustrating an exemplary methodology for rating newly received messages and then updating the rating of such messages in accordance with an aspect of the present invention.

FIG. 5 is a flow diagram illustrating an exemplary methodology for rating newly received messages and then updating the rating of such messages in accordance with an aspect of the present invention.

FIG. 6 illustrates an exemplary user interface for a junk rating property display in accordance with an aspect of the present invention.

FIG. 7 illustrates an exemplary environment for implementing various aspects of the invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “message” as employed in this application is intended to refer to email messages, instant messages, conversations, chat messages, audio messages, and/or any other type of message, such as video messages, newsgroup messages, blog messages, and/or blog comments, that can be subjected to the systems and methods described herein. The terms junk and spam are utilized interchangeably as are the terms recipient and user.

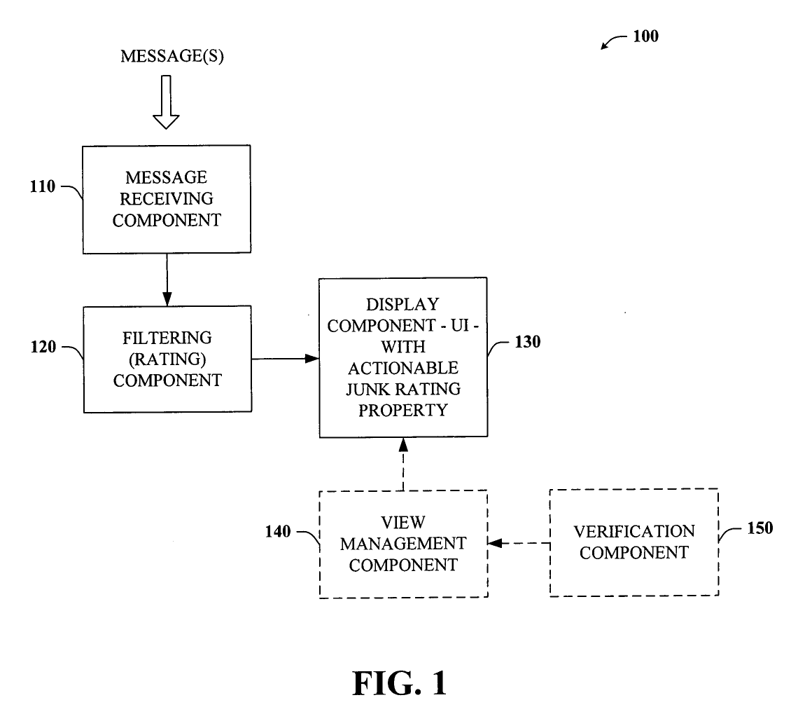

Referring now to FIG. 1, there is a general block diagram of a junk rating interface system 100 that provides a junk rating as an actionable field on a message in accordance with an aspect of the present invention. The system 100 comprises a message receiving component 110 that accepts incoming messages as they arrive at a user's server or personal computer (PC), for example. The incoming messages can be communicated to a filtering component 120 comprising one or more junk filters. The junk filter can score each message based on its spam confidence level, or rather, the likelihood that the message is junk. The score can be a value between 0 and 1, for instance.

Once the message has been scored, it can be bucketized into an appropriate junk rating based at least in part on its junk score. Buckets enable “grouping” as well as “sorting”, whereas an infinite-precision numeric score would only allow sorting. Although there is strong user value in being able to sort and group by junk scores, the junk scoring system needs to be protected from easy reverse engineering by spammers. If available to him, an infinite-precision spam score would let a spammer experiment with subtle variations in his message's content and thus easily learn what effect each word or other feature contributes to his message's overall junk rating. When the scores are instead bucketized, the effects of features are seen only in aggregate, and reverse engineering the junk score is much more difficult.

For example, a plurality of buckets can be provided such that each respective bucket represents a junk rating. Possible junk ratings include but are not limited to unscanned, low, medium, high, very high, safe, junked and/or “not junk”. Specific and/or ranges of junk scores can be associated with the low, medium, high, and very high junk ratings. Conversely, safe, junked, and “not junk” junk ratings may be determined based in part on other data. For example, when a message enters the filtering component 120, the filtering component 120 can first determine whether the sender is known or trusted before scanning the message with the filter. A sender can be identified as “known” when the sender is on a safe list such as a safe sender list or a safe mailing list created by the user. The safe sender list employs a filter that examines a From line of a message whereas a safe mailing list uses a filter that examines a To line of a message. With respect to safe mailing lists, the user can affirm that he desires messages from such mailing lists, as opposed to messages from a particular sender (safe senders list).

Conversely, a blocked senders list can also be employed to identify the sender of messages that the user does not want to receive. Thus, a message sender found on a blocked senders list can be immediately marked as junk and directed to a junk folder. Furthermore, any action the user takes that adds an e-mail address to a safe or block list can as a result modify the junk rating of all messages from that e-mail address. The system 100 can prompt the user to make that action because of the junk rating. As can be seen, the system 100 provides a feedback mechanism that the user can employ to fine tune the junk ratings. For example, if the user replies to a low junk rated e-mail, the system or a component thereof can prompt the user to add the e-mail address to their address book which can result in a change of the original e-mail's junk rating from low to safe.

Moreover, messages having a known and “trusted” sender can be rated as safe and a junk score may not be computed for such messages. Messages sent by untrusted or blocked senders can be treated in a similar manner: marked as junk and not processed through the junk filter. As is discussed in greater detail below, “junked” and “not junk” junk ratings can be assigned to messages in response to a user-based action performed on a message to essentially override a computed junk score and a resulting junk rating.

Still referring to FIG. 1, messages placed in the low bucket can be tagged with a low junk rating and such rating can be added or saved as a property on the message. The junk rating can also be viewed as an actionable field on a user interface by way of a display component 130. The display component can render the junk rating in a column adjacent to any one of the other columns displayed on the user interface. As a result, messages can be viewed, manipulated, and/or organized based on their junk rating by a view management component 140.

In particular, the view management component 140 can facilitate sorting and/or grouping of messages based in part on their junk ratings as well as filtering messages when at least one of a junk score or junk rating exceeds a first threshold. Furthermore, the view management component 140 can assist in setting one or more action-based rules to perform on a message whose junk score or junk rating exceeds a second threshold. For example, messages having a medium junk rating can be moved to a different folder or discarded after a number of days. In addition, the view management component 140 can facilitate visually altering a display of a message listing or message according to the respective junk score or junk rating. This can be accomplished by employing one or more display rules such as color-coding preferences.

The system 100 can also include a verification component 150 that can interact with the view management component 130 by issuing dialog boxes relating to user behavior and/or management of rated messages. In particular, the verification component 150 can assist in confirming whether a user-initiated action on a message is truly desired by that user. For example, when a user attempts to move a junk message from the junk folder to any other folder such as the inbox, a pop-up dialog box can appear to verify or confirm the user's “move” action. Similarly, when a user attempts to reply to a junk message or a message having a junk score or rating in excess of a threshold, the verification component can issue a dialog box to confirm the user's “reply” action.

Various methodologies in accordance with the subject invention will now be described via a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

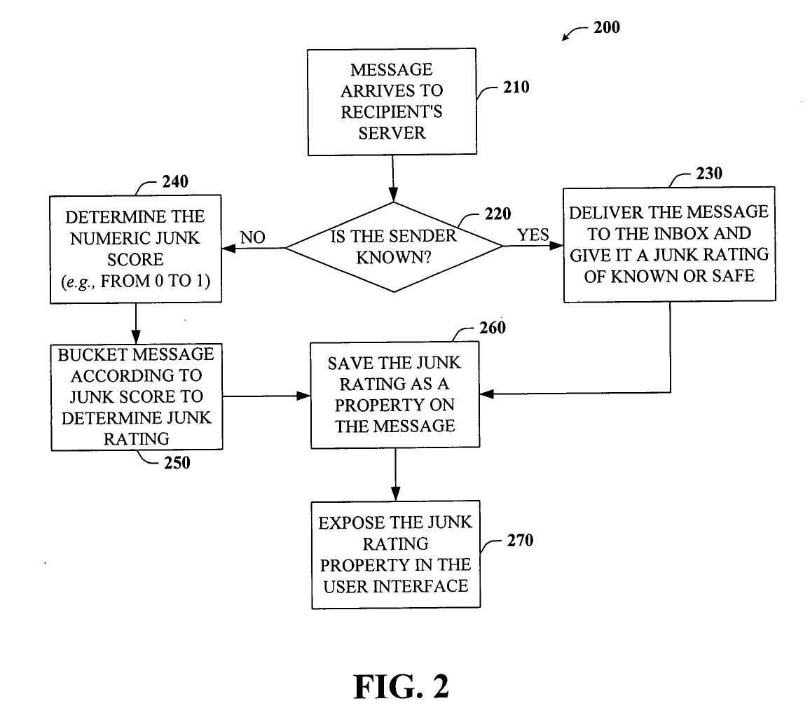

Referring now to FIG. 2, there is a flow diagram of a process 200 that facilitates exposing a junk rating of a message on a user interface as an actionable property on the message. In particular, the process 200 can begin with a message arriving at a recipient's server or PC at 210. At 220, the process 200 can determine if the sender of the particular message is known. If the sender is known (e.g., matches to at least one safe list), then the message can be delivered to the recipient's inbox and given a junk rating of “known” or “safe” at 230. However, if the message sender is not known, then a numeric junk score of the message can be computed at 240. At 250, the message can be bucketed according to its junk score to determine an appropriate junk rating for that message.

Once the junk rating of the message is determined (e.g., either at 230 or at 250), the junk rating can be saved as a property on the message at 260. At 270, the junk rating can be exposed in the user interface along with the relevant message regardless of the folder being viewed. Thus, the junk rating field or property can persist through multiple folders for substantially all messages stored therein.

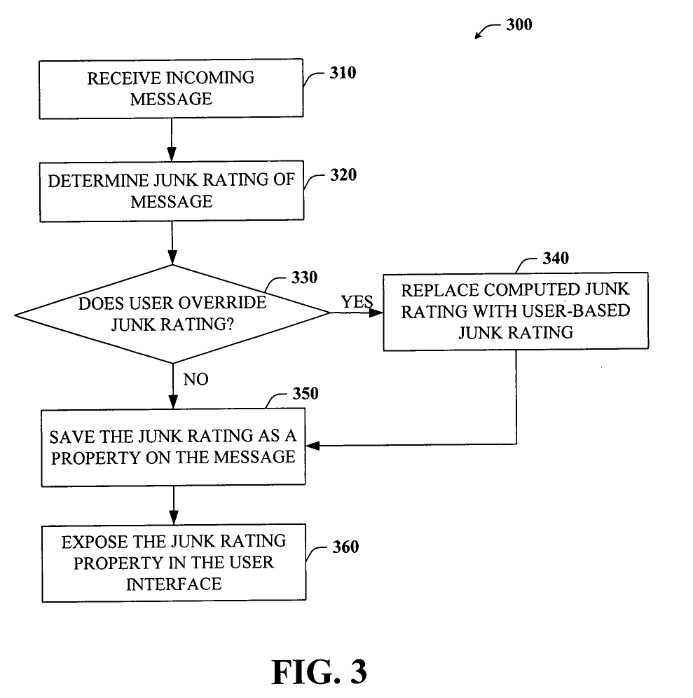

Turning now to FIG. 3, there is a flow diagram of an exemplary process 300 that facilitates updating message junk ratings particularly when a user manually modifies a rated message. The process 300 involves receiving an incoming message at 310 and then determining its junk rating at 320. At 330, the process 300 can determine whether a user has taken action to override the junk rating. One example of such an action occurs when a user moves a message from the inbox to the junk folder, thus changing the current junk rating to a new junk rating: “junked”. If the user has overridden the system-computed or system-assigned junk rating, then the junk rating can be updated to reflect the user's decision at 340. Once the junk rating has been updated, the new junk rating can be saved as a property of the message at 350 and later exposed in the user interface at 360. Any action the user takes that modifies the junk rating of a message such as adding an e-mail address to a safe or block list can result in a modification of the junk rating of all received or future messages from that e-mail address. For instance, when a low rated message is received or opened by the user, the method 300 can prompt the user to add the sender to a safe list because of the junk rating. Consequently, this can serve as another feedback mechanism that the user can take advantage of to fine tune the junk ratings. It should be appreciated that the junk rating property can be modified at any time in the manner described above by a user.

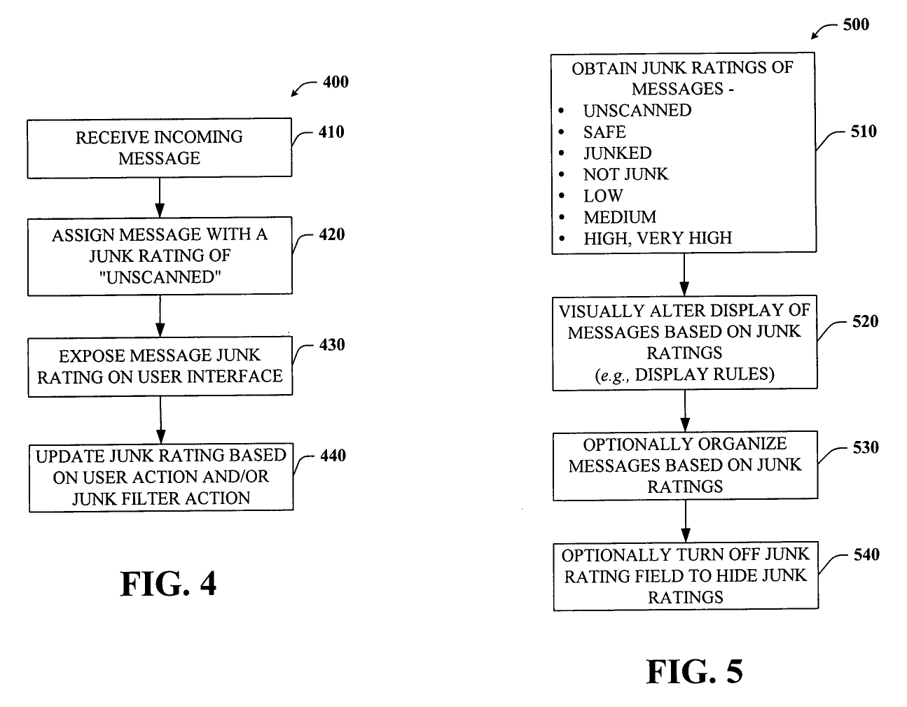

Referring now to FIG. 4, there is illustrated a flow diagram of a process 400 that facilitates rating a message before it has been scanned by a junk filter or any other filtering component in accordance with the present invention. In particular, the process 400 includes receiving a message at 410 and then assigning it with an unscanned junk rating at 420. This indicates that the message has not been scanned by a filter or by any other means to determine whether the sender is known or if the message is junk, for example. Unscanned rated messages can be hidden from view on the user interface or they can be viewed and/or manipulated similar to any other rated message in the user's inbox at 430. The unscanned rating can be subsequently updated such as when the message is further inspected or run through the filter(s) at 440.

FIG. 5 also demonstrates a flow diagram of an exemplary process 500 that facilitates rating and then managing messages according to their respective junk ratings in accordance with the present invention. For example, at 510, the junk ratings of a plurality of incoming messages can be obtained. Possible junk ratings include unscanned, safe, junked, not junk, and varying degrees of low, medium, or high (e.g., very high) or related variations thereof. At 520, the display of the messages can be visually altered based at least in part on the respective junk ratings by way of one or more display rules. For instance, messages can be color-coded and/or shown in various fonts or font sizes depending on their junk ratings. The alteration in the display of messages based on their junk rating can further facilitate the viewing of only desired messages and mitigate the unintentional viewing of misplaced (in the inbox rather than in the junk folder) junk messages. For example, messages having a rating of medium or above can be “hidden” such that the user can toggle between a variety of different display options.

At 530, the messages can be organized, sorted, or grouped according to their junk ratings. However, the junk rating property on the user interface can be turned off at the discretion of the user. When turned off, no junk ratings or scores can be viewed in any particular folder including the junk folder. However, substantially all view management techniques including sorting, filtering, grouping, actions, and the like can be performed on a property that is invisible to the user.

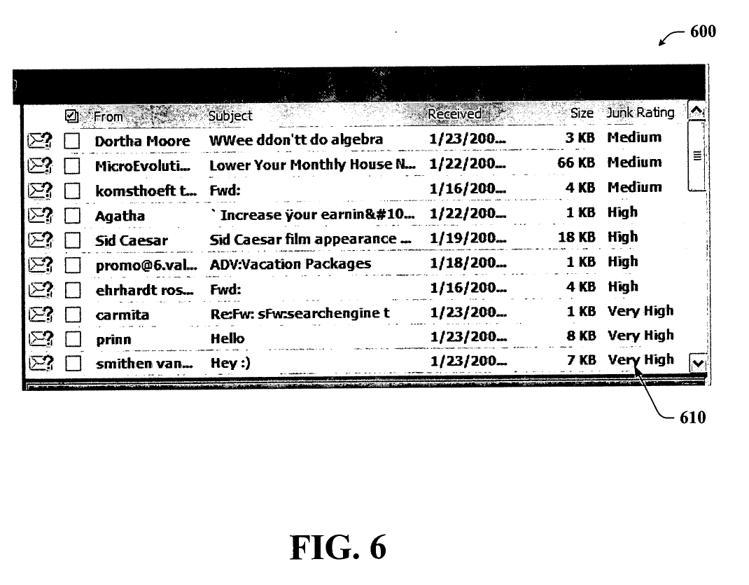

Referring now to FIG. 6, there is a screen capture of an exemplary user interface 600 that facilitates viewing and managing incoming messages based at least in part on their corresponding junk ratings. The user interface 600 comprises a junk rating property field or column 610 which explicitly shows the junk rating of each message. The junk rating directly corresponds to a junk score value which can be computed by a junk filter, for example. The junk rating can also depend on such factors such as if the sender is known or trusted to the recipient or if the recipient manually moved the message between a junk folder and another folder to change its junk state. As can be seen in the figure, the junk rating column can be selected to facilitate sorting messages according to their junk rating.

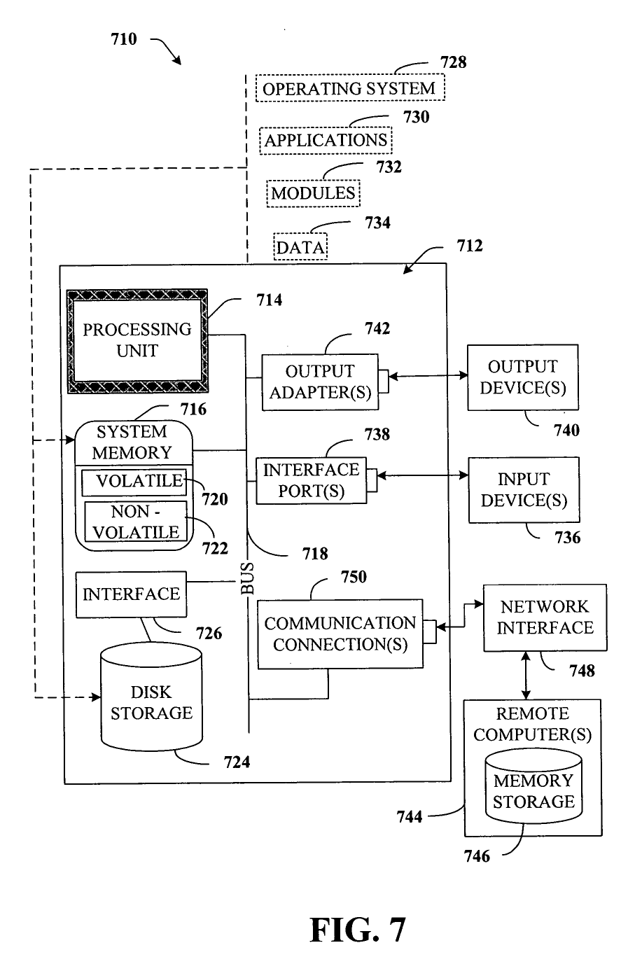

In order to provide additional context for various aspects of the present invention, FIG. 7 and the following discussion are intended to provide a brief, general description of a suitable operating environment 710 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 710 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 7, an exemplary environment 710 for implementing various aspects of the invention includes a computer 712. The computer 712 includes a processing unit 714, a system memory 716, and a system bus 718. The system bus 718 couples system components including, but not limited to, the system memory 716 to the processing unit 714. The processing unit 714 can be any of various available processors. Dual microprocessors and other multiprocessor architectures also can be employed as the processing unit 714.

The system bus 718 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 716 includes volatile memory 720 and nonvolatile memory 722. The basic input/output system (BIOS), containing the basic routines to transfer information between elements within the computer 712, such as during start-up, is stored in nonvolatile memory 722. By way of illustration, and not limitation, nonvolatile memory 722 can include read only memory (ROM), programmable ROM (PROM), electrically programmable ROM (EPROM), electrically erasable ROM (EEPROM), or flash memory. Volatile memory 720 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 712 also includes removable/nonremovable, volatile/nonvolatile computer storage media. FIG. 7 illustrates, for example a disk storage 724. Disk storage 724 includes, but is not limited to, devices like a magnetic disk drive, floppy disk drive, tape drive, Jaz drive, Zip drive, LS-100 drive, flash memory card, or memory stick. In addition, disk storage 724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 724 to the system bus 718, a removable or non-removable interface is typically used such as interface 726.

It is to be appreciated that FIG. 7 describes software that acts as an intermediary between users and the basic computer resources described in suitable operating environment 710. Such software includes an operating system 728. Operating system 728, which can be stored on disk storage 724, acts to control and allocate resources of the computer system 712. System applications 730 take advantage of the management of resources by operating system 728 through program modules 732 and program data 734 stored either in system memory 716 or on disk storage 724. It is to be appreciated that the present invention can be implemented with various operating systems or combinations of operating systems.

A user enters commands or information into the computer 712 through input device(s) 736. Input devices 736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 714 through the system bus 718 via interface port(s) 738. Interface port(s) 738 include, for example, a serial port, a parallel port, a game port, and a universal serial bus (USB). Output device(s) 740 use some of the same type of ports as input device(s) 736. Thus, for example, a USB port may be used to provide input to computer 712, and to output information from computer 712 to an output device 740. Output adapter 742 is provided to illustrate that there are some output devices 740 like monitors, speakers, and printers among other output devices 740 that require special adapters. The output adapters 742 include, by way of illustration and not limitation, video and sound cards that provide a means of connection between the output device 740 and the system bus 718. It should be noted that other devices and/or systems of devices provide both input and output capabilities such as remote computer(s) 744.

Computer 712 can operate in a networked environment using logical connections to one or more remote computers, such as remote computer(s) 744. The remote computer(s) 744 can be a personal computer, a server, a router, a network PC, a workstation, a microprocessor based appliance, a peer device or other common network node and the like, and typically includes many or all of the elements described relative to computer 712. For purposes of brevity, only a memory storage device 746 is illustrated with remote computer(s) 744. Remote computer(s) 744 is logically connected to computer 712 through a network interface 748 and then physically connected via communication connection 750. Network interface 748 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 750 refers to the hardware/software employed to connect the network interface 748 to the bus 718. While communication connection 750 is shown for illustrative clarity inside computer 712, it can also be external to computer 712. The hardware/software necessary for connection to the network interface 748 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A junk message interface system that facilitates identifying junk messages comprising:
a message receiving component that collects at least one incoming message;
a filtering component that determines a junk score for the incoming message; and
a display component that renders the junk scores as an actionable property on a user interface to facilitate user management of incoming junk messages.

2. The junk message interface system of claim 1, further comprising a view management component that provides one or more ways the user can modify treatment of the junk messages.

3. The junk message interface system of claim 2, the view management component comprises any one of the following ways to mitigate against inadvertently opening a junk message comprising:
sorting and/or grouping messages based at least in part on at least one of their respective junk scores and their respective junk ratings;
filtering out messages with at least one of a junk score or a junk rating that does not satisfy at least a first criterion;
setting one or more actions to take against the messages when at least one of the respective junk scores or junk ratings that do not satisfy at least a second criterion; and
visually altering displays of messages according to at least one of their respective junk scores or junk ratings.

4. The junk message interface system of claim 3, the first criterion is configurably different from the second criterion.

5. The junk message interface system of claim 3, at least one of the first and second criteria is determined according to user preferences.

6. The junk message interface system of claim 3, visually altering the displays comprises color-coding, changing fonts, font sizes, backgrounds, adding or altering images, and/or adding or altering sounds associated with the respective messages based at least in part on their respective junk scores.

7. The junk message interface system of claim 1, further comprising an analysis component that examines junk scores of the incoming messages and orders them based at least in part on a spam confidence level associated with the respective messages.

8. The junk message interface system of claim 1, the display component is a user-interface that exposes a message's junk score to a user so that the user can organize its messages based in part on the respective junk scores.

9. The junk message interface system of claim 1, the filtering component further determines whether a source of the message appears to be trusted based on at least one of the following: user's blocked senders list, safe-list, address book, and safe-mailing list.

10. The junk message interface system of claim 1, further comprising a verification component that requests confirmation regarding user-initiated actions on rated messages.

11. The junk message interface system of claim 10, the verification component fails user requests to perform an action with respect to a junk message until the user requests are verified by the users.

12. The junk message interface system of claim 1, further comprising a bucketing component that bucketizes junk scores of messages so that the effects of features are seen only in aggregate, thereby mitigating reverse engineering of the junk score.

13. A user interface that facilitates identifying junk messages comprising
a junk rating field that can be acted upon by a user, the junk rating being determined at least in part upon determining a junk score and at least in part upon an analysis of the junk score.

14. The user interface of claim 13, messages can be sorted and/or grouped according to their respective junk ratings.

15. A method that facilitates identification of junk messages in a user's inbox comprising:
receiving a plurality of incoming messages;
assigning a junk rating to the messages; and
exposing at least the junk rating on a user interface.

16. The method of claim 15, further comprising calculating a junk score for substantially all incoming messages.

17. The method of claim 16, further comprising bucketizing the junk scores so that the effects of features are seen only in aggregate, thereby mitigating reverse engineering of the junk score.

18. The method of claim 15, further comprising organizing junk messages based at least in part upon their junk rating.

19. The method of claim 15, further comprising determining whether at least one of the junk score or the junk rating exceed a first threshold; and removing messages that exceed the first threshold to mitigate inadvertent access of them by the user.

20. The method of claim 19, removing messages that exceed the first threshold before they are viewable on the user interface.

21. The method of claim 15, the junk rating is based at least in part on one of the following: junk score, one or more safe lists, one or more safe sender lists, user-based actions, and/or user-generated address book.

22. The method of claim 21, user-based actions comprises at least one of the following:
unjunking a message by moving it from a junk state to a non-junk state resulting in an “unjunked” junk rating;
junking a message by moving it from a non-junk state to a junk state resulting in a “junked” junk rating; and
adding a sender to one or more safe lists to change the junk rating of the message to safe.

23. The method of claim 22, the user-based actions affect the junk rating of the message and/or future messages received from a particular sender.

24. The method of claim 15, assigning a junk rating to messages commensurate with at least their respective junk scores.

25. The method of claim 15, assigning a junk rating comprises:
providing a plurality of buckets comprising at least the following categorized buckets: an unscanned bucket, a light bucket, a medium bucket, and a high bucket, the plurality of buckets respectively assigned to a range of junk score values;
dropping messages into respective buckets based at least in part on their calculated junk score such that the respective bucket determines the junk rating for the respective messages.

26. The method of claim 15, further comprising exposing respective junk scores for the messages.

27. A system that facilitates identification of junk messages in a user's inbox comprising:
means for receiving a plurality of incoming messages;
means for calculating a junk score for substantially all incoming messages;
means for assigning a junk rating to the messages commensurate with at least their respective junk scores; and
means for exposing at least one of the junk rating and the junk store on a user interface.

28. A data packet adapted to be transmitted between two or more computer processes facilitating easier viewing and management of incoming messages, the data packet comprising: information associated with receiving a plurality of incoming messages; assigning a junk rating to the messages commensurate with at least their respective junk scores; and exposing at least one of the junk rating and the junk store on a user interface.

29. A computer readable medium having stored thereon the system of claim 1.
